(19) United States
(12) Patent Application Publication
(10) Pub. No.: US 2016/0048567 A1
(43) Pub. Date: Feb. 18, 2016

(54) SEARCH QUERY REFINEMENT INTERFACE

(71) Applicant: Google Inc., Mountain View, CA (US)

(72) Inventors: Rohit Navalgund RAO, Washington, DC (US); Justin Scott Cohen, Arlington, VA (US); Philippe Beaudoin, Mont-Royal (CA)

(73) Assignee: Google Inc., Mountain View, CA (US)

(21) Appl. No.: 14/040,415

(22) Filed: Sep. 27, 2013

(51) Int. Cl. G06F 17/30

(52) U.S. Cl. CPC G06F 17/30554

(57) ABSTRACT

Methods for providing an interface to refine a search query are provided. In one aspect, a method includes receiving a submission of a first search query in an input field, and providing, for display, the first search query in the input field with first search results for the search query, the first search results including at least one subset category of search results. The method also includes receiving a selection of the at least one subset category of the first search results, and providing, for display, an indicator of the selected at least one subset category in the input field with second search results for the selected at least one subset category. Systems and machine-readable media are also provided.

### BACKGROUND

1. Field

The present disclosure generally relates to the transmission of data over a network, and more particularly to the use of a computing device to provide data requested over a network.

2. Description of the Related Art

Web browsers commonly provide a single input field (or “omnibox”) in which a user may enter an address for a web page to load or a search query to be searched using a search provider. When an entered search query is submitted by the user using the input field, a web page of search results is often displayed in the web browser. The search results may include subset categories for the search query, such as images identified by the search query, items on sale identified by the search query, news identified by the search query, and so on. If the user selects a subset category from the search results, the single input field usually still identifies the original search query even though the search query has been modified by being limited to the selected subset category.

### SUMMARY

According to certain embodiments of the present disclosure, a computer-implemented method for providing an interface to refine a search query is provided. The method includes receiving a submission of a first search query in an input field, and providing, for display, the first search query in the input field with first search results for the search query, the first search results including at least one subset category of search results. The method also includes receiving a selection of the at least one subset category of the first search results, and providing, for display, an indicator of the selected at least one subset category in the input field with second search results for the selected at least one subset category.

According to certain embodiments of the present disclosure, a system for providing an interface to refine a search query is provided. The system includes a memory that includes instructions, and a processor. The processor is configured to execute the instructions to receive a submission of a first search query in an input field, and provide, for display, the first search query in the input field with first search results for the search query, the first search results including at least one subset category of search results. The processor is also configured to execute the instructions to receive a selection of the at least one subset category of the first search results, and provide, for display, an indicator of the selected at least one subset category in the input field with second search results for the selected at least one subset category. The processor is further configured to execute the instructions to receive a submission of a second search query in the input field after the second search results for the selected at least one subset category are provided for display, and provide, for display, third search results for the second search query limited to the selected at least one subset category.

According to certain embodiments of the present disclosure, a machine-readable storage medium that includes machine-readable instructions for causing a processor to execute a method for providing an interface to refine a search query is provided. The method includes receiving a submission of a first search query in an input field, and providing, for display, the first search query in the input field with first search results for the search query, the first search results including at least one subset category of search results. The method also includes receiving a selection of the at least one subset category of the first search results, and providing, for display, an indicator of the selected at least one subset category in the input field with second search results for the selected at least one subset category. The method further includes providing the indicator of the selected at least one subset category in the input field in response to a user selecting the input field after the second search results for the selected at least one subset category are provided for display. The providing, for display, the first search query in the input field with the first search results for the search query is limited to the first search results being provided using a secure connection. When the first search results are not provided using a secure connection, the method includes providing, for display, an address in the input field associated with a web page that includes the first search results to the first search query.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for providing an interface to refine a search query.

FIG. 2 is a block diagram illustrating the example client and server from the architecture of FIG. 1 according to certain aspects of the disclosure.

FIG. 3 illustrates an example process for providing an interface to refine a search query using the example client of FIG. 2.

FIGS. 4A-4F are example illustrations associated with the example process of FIG. 3.

FIG. 5 is a block diagram illustrating an example computer system with which the client and server of FIG. 2 can be implemented.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The disclosed application, which can be, for example, a web browser or search application, is configured to receive a search query entered into an input field and maintain a display of the search query in the input field after a request is submitted to search for the search query and search results are displayed. In certain aspects, the search query is maintained for display in the input field if the search results are displayed using a secure (e.g., Secure Socket Layer) connection. Thereafter, if a subset category of the search results is selected, the input field of the web browser is updated to reflect the selected subset category, for example, with a visual indicator identifying the selected subset category, along with the originally submitted search query. If a change to the search query is submitted while viewing the selected subset category of results, the input field is updated to reflect he changed search query while continuing to limit the search results to the selected subset category.

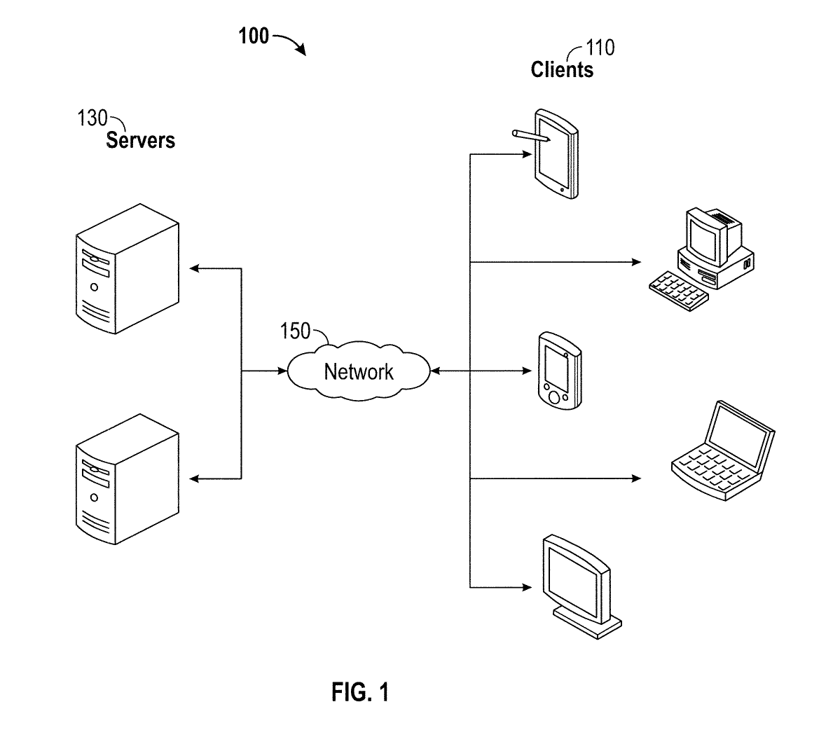

FIG. 1 illustrates an example architecture 100 for providing an interface to refine a search query. The architecture 100 includes servers 130 and clients 110 connected over a network 150.

Each client 110 is configured to execute an application for viewing a document that includes a search input field. The clients 110 can be, for example, desktop computers, mobile computers, tablet computers (e.g., including e-book readers), mobile devices (e.g., a smartphone or PDA), set top boxes (e.g., for a television), video game consoles, or any other devices having appropriate processor, memory, and communications capabilities. The application can be, for example, a web browser, and the document can be, for example, a web page for an online search engine. When a user submits input into the search input field, the application displays search results for the user based on the submitted input. Optionally, the input provided may remain in the search input field after the search results are provided (e.g., as opposed to the address of the web page providing the search results) in order to permit the user to more easily change the input. In certain aspects, the input remains in the search input field if the search results are provided over a secure (e.g., Secure Socket Layer) connection, but the address of the web page providing the search results appears if the search results are not provided over a secure connection. As such, the user may more easily identify whether the search results are from an authorized or otherwise secure source.

The search results may be, for example, links to web pages and/or web page addresses (e.g., URLs). The search results can include results from various categories, such as web pages, images, videos, items for sale, publications, and news. The search may be refined to one or many of the various categories. The application for viewing the document that includes the search input field, whether an input field in the document or in the application, is configured to provide a graphical user interface indicative of the refinement to the one or many categories of search results. This permits a user to directly conduct a subsequent search within the selected category without having to re-select the category for searching.

The search results may be provided from various sources, such as a local database if the search is directed to the local database, or from a remote database over a network 150 of a search engine hosted on one or many of the servers 130. For purposes of load balancing, multiple servers 130 can host the search engine and related database, either separately (e.g., as replicated copies) or in part.

The servers 130 can be any device having an appropriate processor, memory, and communications capability for hosting a search engine. The network 150 can include, for example, any one or more of a personal area network (PAN), a local area network (LAN), a campus area network (CAN), a metropolitan area network (MAN), a wide area network (WAN), a broadband network (BBN), the Internet, and the like. Further, the network 150 can include, but is not limited to, any one or more of the following network topologies, including a bus network, a star network, a ring network, a mesh network, a star-bus network, tree or hierarchical network, and the like.

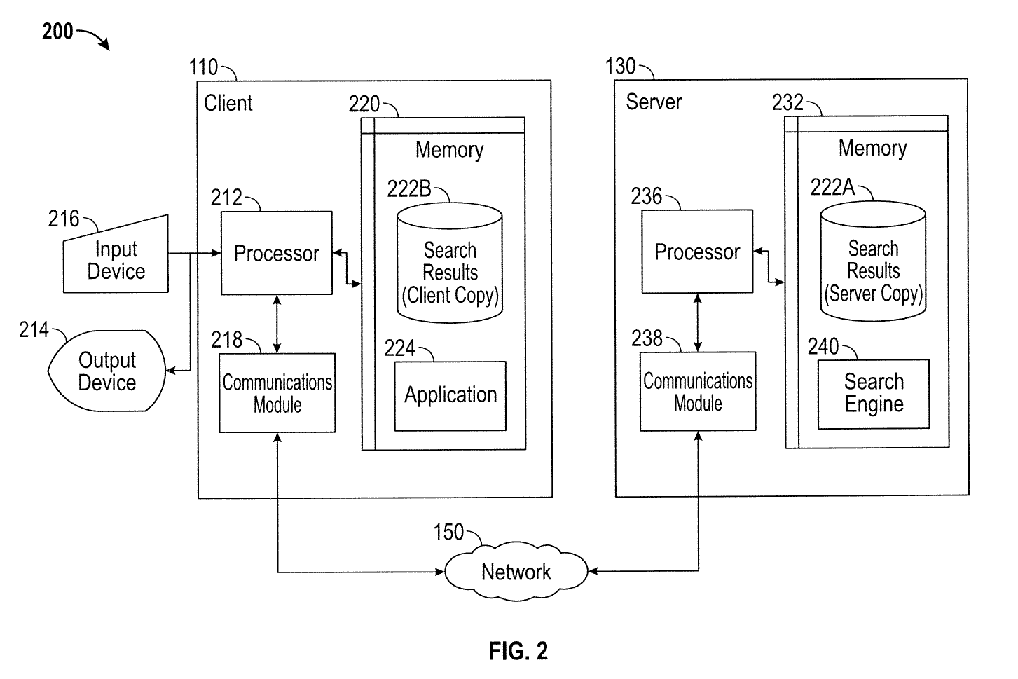

FIG. 2 is a block diagram 200 illustrating an example server 130 and client 110 in the architecture 100 of FIG. 1 according to certain aspects of the disclosure. The client 110 and the server 130 are connected over the network 150 via respective communications modules 218 and 238. The communications modules 218 and 238 are configured to interface with the network 150 to send and receive information, such as data, requests, responses, and commands to other devices on the network. The communications modules 218 and 238 can be, for example, modems or Ethernet cards.

The server 130 includes a processor 236, a communications module 238, and a memory 232 that includes a search engine 240. The processor 236 of the server 130 is configured to execute instructions, such as instructions physically coded into the processor 236, instructions received from software (e.g., the search engine 240) in memory 232, or a combination of both, to receive a request for a search (e.g., over the network 110 from the client 110) and provide search results 222A, including suggestions for searches, in response to the request.

The client 110 includes a processor 212, the communications module 218, and memory 220 that includes an application 224. The application 224 can be, for example, a web browser, search application, database, or other application configured to receive a search query and provide search results for display in response to the search query. In certain aspects, the client 110 is a mobile device such as a tablet or smartphone. In certain aspects, the search results 222A are provided from the search engine 240 over the network 150 in response to a request from the client 110 and stored as a client copy of the search results 222B in the memory 220 of the client 110. In certain aspects the server 130 is not needed where, for example, the application 224 can perform a search that is limited to the client 110 and that does not require a connection to the network 150.

The client 110 includes an input device 216, such as a keyboard, mouse, touchpad, or touchscreen, for receiving the search query and an output device 214, such as a display, for providing search results for display in the application 224 in response to the search query. The processor 212 of the client 110 is configured to execute instructions, such as instructions physically coded into the processor 212, instructions received from software (e.g., the application 224) in memory 240, or a combination of both, for providing an interface to refine a search query. For example, the processor 212 of the client 110 executes instructions to receive a submission of a first search query in an input field (e.g., of the application 224). In certain aspects, an active step of submitting the first search query (e.g., by touching a “submit” or “enter” button) is taken by the client 110 and/or a user of the client 110. In certain aspects, the input field can be an omnibox configured to receive both a search query and an address of a webpage. The processor 212 is further configured to provide, for display (e.g., on the output device 214), the first search query in the input field with a first set of search results 222B (or “first search results”) for the search query.

In certain aspects, the first search query is limited to being provided for display (e.g., on the output device 214) in the input field with the first search results by the processor 212 when the first search results are provided using a secure connection. The secure connection can be, for example, a Transport Layer Security (TLS) connection, Secure Sockets Layer (SSL) connection, or other cryptographic protocol that provides communication security over the network 150. When the first search results are not provided using a secure connection, the processor 212 may instead provide, for display, an address in the input field associated with a web page that includes the first search results to the first search query. For example, if a user submits a search query for “toys” in input field of the application 224 and the search engine 240 of the server 130 returns search results 222A using a secure connection over the network 150, the application will continue to display the search query “toys” in the input field of the application 224 along with the search results. On the other hand, if the user submits the search query for “toys” in input field of the application 224 and the search engine 240 of the server 130 returns search results 222A using an unsecure connection over the network 150, the application will instead display a web page address in the input field for the search results for the search query “toys”.

The first search results include at least one subset category of search results. The categories can be, for example, web pages, images, videos, items for sale, maps, news, books, blogs, flights, discussions, recipes, and publications. For example, a user that submits a search query “cars” can be provided with a first set of search results for “cars” that includes subset categories having links to web pages for cars, images of cars, videos of cars, cars for sale, local car stores, car related news, books on cars, blogs on cars, discussions of cars, and publications on cars.

The processor 212 is also configured to receive a selection (e.g., from a user or by the application 224) of at least one subset category of the first search results (e.g., from among possibly a plurality of subset categories, examples of which are provided above), and provide, for display, an indicator of the selected subset category in the input field with second search results for the selected at least one subset category. The second search results are for the selected subset category. For example, if a user selected the subset category of images for the search query “cars”, then the second search results would be images for the search query “cars”. The indicator in the input field indicative of the selected subset category can be, for example, a text or image description of the selected subset category. For example, for the selected subset category of images for the search query “cars”, the input field can include the word “images” or an illustration of a picture.

The indicator of the selected subset category can be provided in the input field in response to a user selecting the input field after the second search results for the selected at least one subset category are provided for display. For example, when a user viewing the second search results for the search query “cars” places a cursor in the input field, the input field may display the word “images” or the illustration of the picture in order to indicate the search results are for the subset category “images”.

In certain aspects, the indicator, in the input field, of the selected subset category replaces another indicator in the input field indicating a search that is not limited to a subset category. For example, the word “images” or illustration of the picture can replace a word “all” or an illustration of a magnifying glass. Additionally, in certain aspects, an option to deselect the selected subset category may be displayed in the input field. For example, the option can be displayed as an “X” button that when selected deselects the selected subset category and permits a general search to be submitted.

The processor 212 is yet further configured to receive a submission of a second search query in the input field while the second search results for the selected subset category are provided for display, and provide, for display, third search results for the second search query limited to the selected subset category. For example, a user viewing the subset category images for the search query “cars” may then enter the search query “boats” in the input field of the application 224. Upon submission of the search query “boats”, images of boats will be displayed in the search results due to the subset category images remaining active or otherwise selected for the updated search query “boats”.

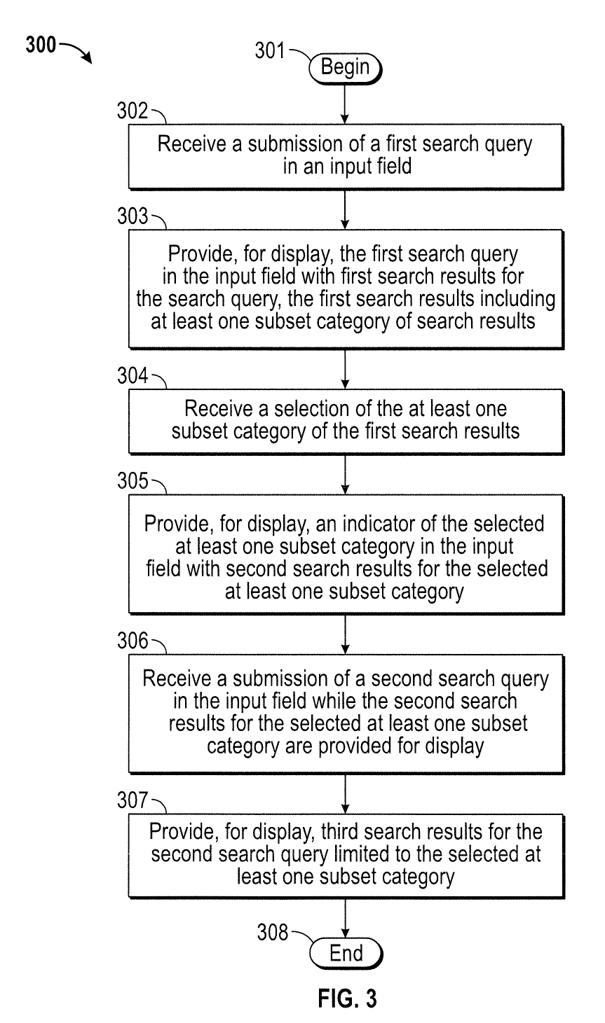

FIG. 3 illustrates an example process 300 for providing an interface to refine a search query using the example client 110 of FIG. 2. While FIG. 3 is described with reference to FIG. 2, it should be noted that the process steps of FIG. 3 may be performed by other systems.

The process 300 begins by proceeding from beginning step 301 when the application 224 is launched on the client 110 to step 302 when a submission of a first search query is received in an input field of the application 224. Next, in step 303, the application 224 provides, for display, the first search query in the input field with first search results for the search query. The first search results may be provided by the search engine 240 on the server 130 over the network 150 in response to a request from the application 224. The first search results include at least one subset category of search results.

In step 304, the application 224 receives a selection of the subset category of the first search results, for example, using the input device 216 of the client 110, and in step 305 provides, for display (e.g., in the graphical user interface of the application 224 displayed on the output device 214), an indicator of the selected subset category in the input field with second search results for the selected at least one subset category. Subsequently, in step 306, the application 224 receives a submission of a second search query in the input field after the second search results for the selected at least one subset category are provided for display, and in step 307 provides, for display, third search results for the second search query limited to the selected at least one subset category. The process 300 then ends in step 308.

FIG. 3 set forth an example process 300 for providing an interface to refine a search query using the example client 110 of FIG. 2. An example will now be described using the example process 300 of FIG. 3, a client 110 that is a smartphone, and an application 224 that is a web browser.

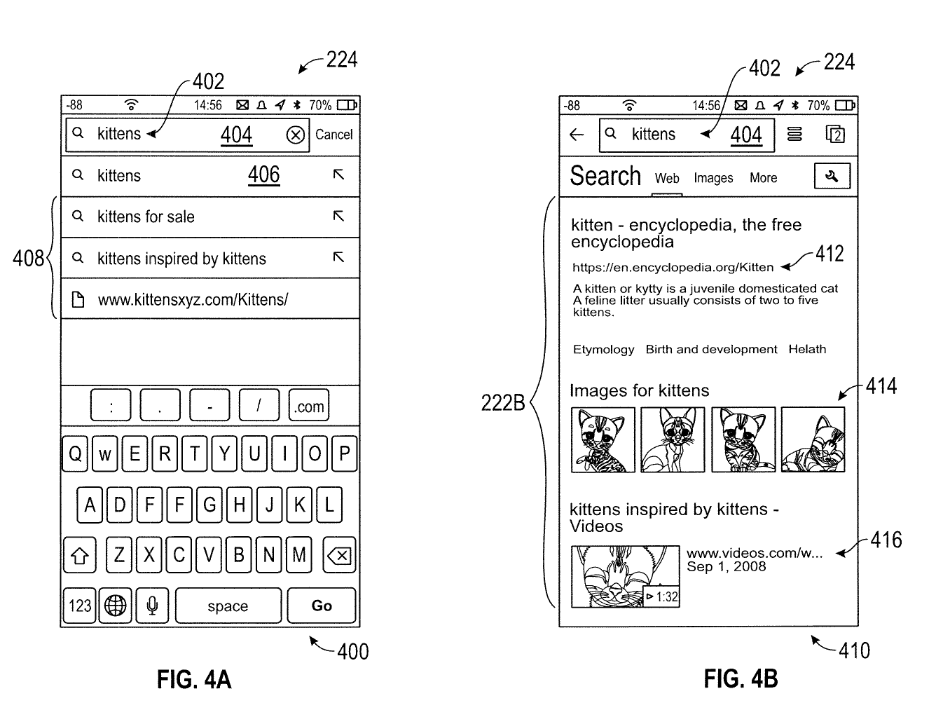

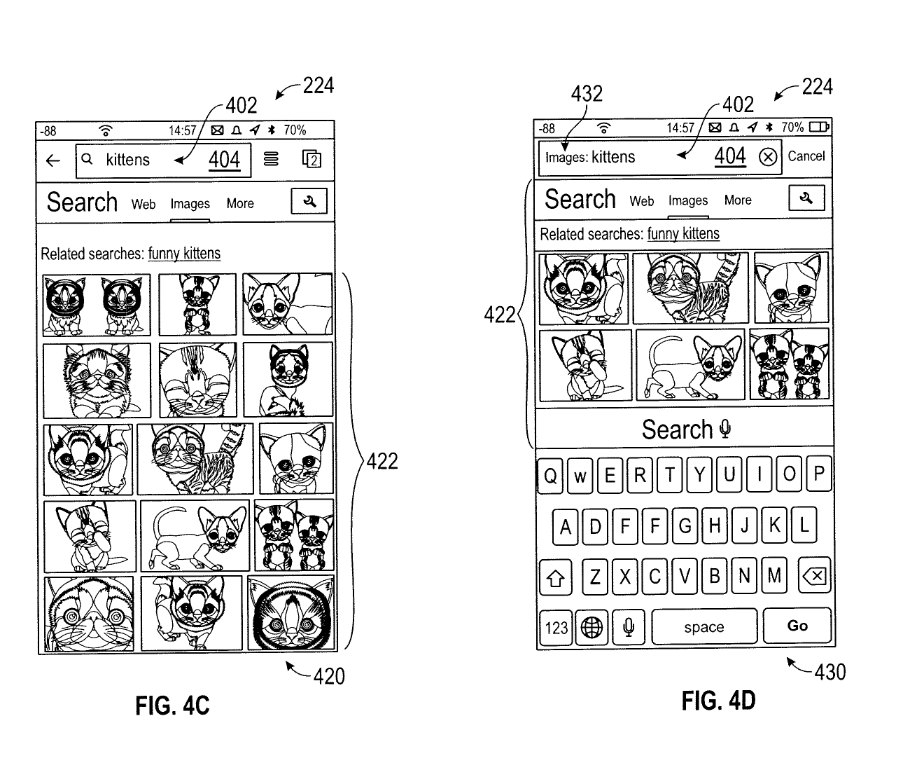

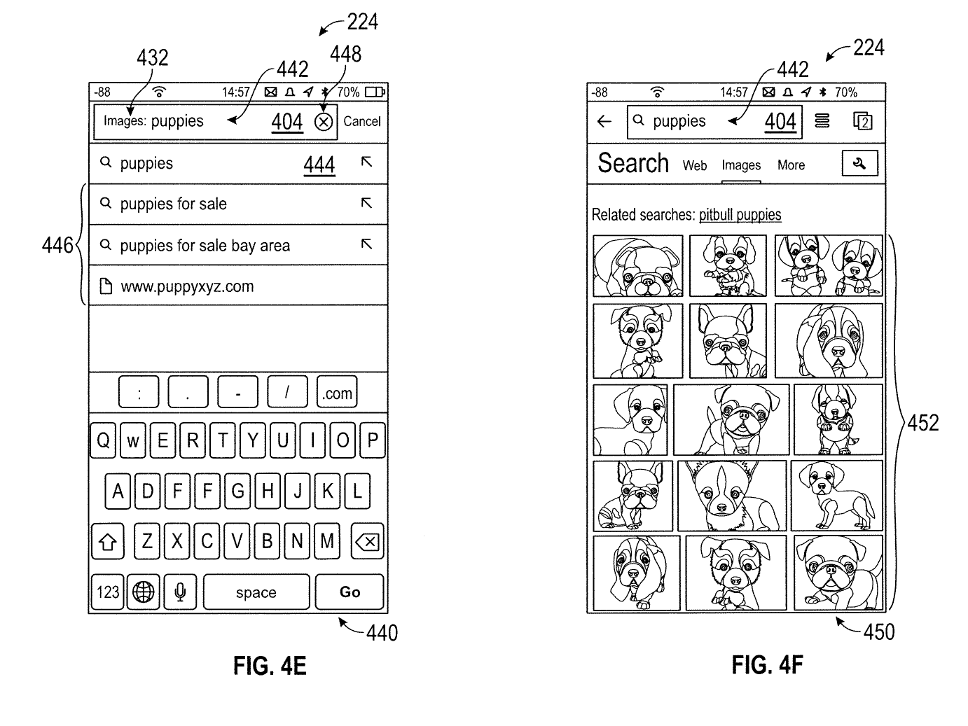

The process 300 begins by proceeding from beginning step 301 when the web browser 224 is launched on the client 110 to step 302 when a submission of a first search query, “kittens” is received in an omnibox of the web browser 224. FIG. 4A provides an example illustration 400 of the web browser 224 in which the first search query “kittens” 402 has been entered in the omnibox 404 of the web browser 224. The web browser 224 also provides, for display, a suggestion 406 to search for the first search query 402, as well as other suggestions 408 related to the first search query provided by the search engine 240.

Next, in step 303, the web browser 224 provides, for display, the first search query “kittens” 402 in the omnibox 404 with first search results 222B for the search query as provided in the example illustration 410 of FIG. 4B. The first search results 2228 are provided by the search engine 240 on the server 130 over the network 150 in response to a request from the web browser 224. The first search results 222B include at least three subset categories of search results: web pages 412, images 414, and videos 416.

In step 304, the web browser 224 receives a selection of the images subset category 414 of the first search results using the touch input interface 216 of the smartphone 110 as provided in the example illustration 420 of FIG. 4C, and second search results 422 are provided for display in the web browser 224. In step 305 the web browser 224 provides, for display, an indicator, the word “images” 432, of the selected images subset category 414 along with the first search query “kittens” 402 in the omnibox 404. The selected subset category indicator “images” 432 in the omnibox 404 is provided for display in response to the user of the smartphone 110 selecting the omnibox 404 (e.g., by touching the omnibox 404 to place a cursor in the omnibox 404). The web browser 224 provides the omnibox with the selected subset category indicator “images” 432 for display with the second search results 422 for the selected images subset category 414.

Subsequently, in step 306, the web browser 224 receives a submission of a second search query “puppies” 442 in the omnibox 404 after the second search results for the selected at least one subset category are provided for display as provided in the example illustration 440 of FIG. 4E. The web browser 224 also provides, for display, a suggestion 444 to search for the second search query 442, as well as other suggestions 446 related to the second search query 442 provided by the search engine 240. The web browser 224 also provides for display an “x”-button option 448 in the omnibox 404 to deselect the selected image subset category prior to submitting a request to search for the second search query 442. Subsequently, in step 307, the web browser 224 provides, for display, third search results 452 for the second search query “puppies” 442 limited to the selected images subset category. The process 300 then ends in step 308.

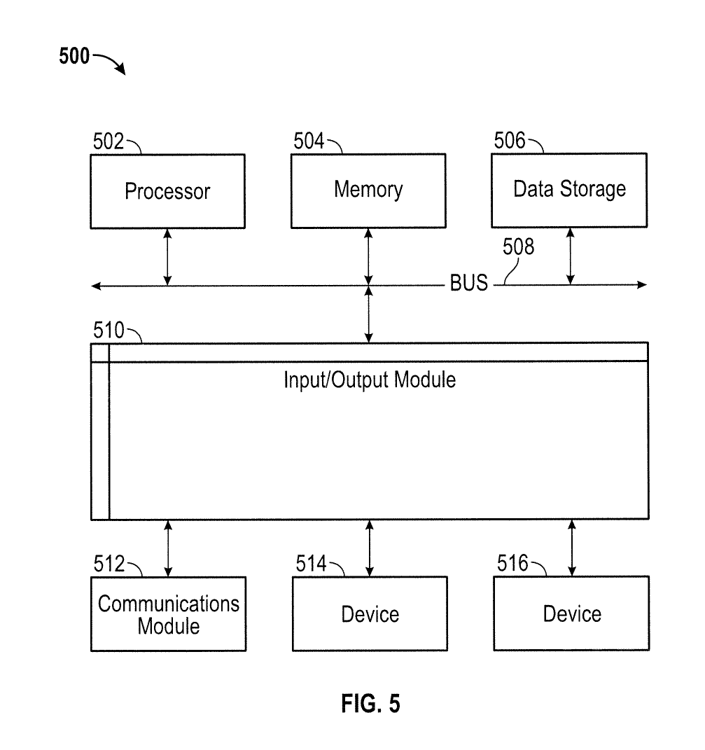

FIG. 5 is a block diagram illustrating an example computer system 500 with which the client 110 and server 130 of FIG. 2 can be implemented. In certain aspects, the computer system 500 may be implemented using hardware or a combination of software and hardware, either in a dedicated server, or integrated into another entity, or distributed across multiple entities.

Computer system 500 (e.g., client 110 and server 130) includes a bus 508 or other communication mechanism for communicating information, and a processor 502 (e.g., processor 212 and 236) coupled with bus 508 for processing information. By way of example, the computer system 500 may be implemented with one or more processors 502. Processor 502 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 500 can include, in addition to hardware, code that creates an execution environment for the computer program in question, e.g., code that constitutes processor firmware, a protocol stack, a database management system, an operating system, or a combination of one or more of them stored in an included memory 504 (e.g., memory 220 and 232), such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 508 for storing information and instructions to be executed by processor 502. The processor 502 and the memory 504 can be supplemented by, or incorporated in, special purpose logic circuitry.

The instructions may be stored in the memory 504 and implemented in one or more computer program products, i.e., one or more modules of computer program instructions encoded on a computer readable medium for execution by, or to control the operation of, the computer system 500, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, embeddable languages, and xml-based languages. Memory 504 may also be used for storing temporary variable or other intermediate information during execution of instructions to be executed by processor 502.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 500 further includes a data storage device 506 such as a magnetic disk or optical disk, coupled to bus 508 for storing information and instructions. Computer system 500 may be coupled via input/output module 510 to various devices. The input/output module 510 can be any input/output module. Example input/output modules 510 include data ports such as USB ports. The input/output module 510 is configured to connect to a communications module 512. Example communications modules 512 (e.g., communications module 218 and 238) include networking interface cards, such as Ethernet cards and modems. In certain aspects, the input/output module 510 is configured to connect to a plurality of devices, such as an input device 514 (e.g., input device 216) and/or an output device 516 (e.g., output device 214). Example input devices 514 include a keyboard and a pointing device, e.g., a mouse or a trackball, by which a user can provide input to the computer system 500. Other kinds of input devices 514 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback; and input from the user can be received in any form, including acoustic, speech, tactile, or brain wave input. Example output devices 516 include display devices, such as a LED (light emitting diode), CRT (cathode ray tube), or LCD (liquid crystal display) screen, for displaying information to the user.

According to one aspect of the present disclosure, the client 110 and server 130 can be implemented using a computer system 500 in response to processor 502 executing one or more sequences of one or more instructions contained in memory 504. Such instructions may be read into memory 504 from another machine-readable medium, such as data storage device 506. Execution of the sequences of instructions contained in main memory 504 causes processor 502 to perform the process steps described herein. One or more processors in a multi-processing arrangement may also be employed to execute the sequences of instructions contained in memory 504. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network (e.g., network 150) can include, for example, any one or more of a personal area network (PAN), a local area network (LAN), a campus area network (CAN), a metropolitan area network (MAN), a wide area network (WAN), a broadband network (BBN), the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computing system 500 can include clients and servers. A client and server are generally remote from each other and typically interact through a communication network. The relationship of client and server arises by virtue of computer programs running on the respective computers and having a client-server relationship to each other. Computer system 500 can be, for example, and without limitation, a desktop computer, laptop computer, or tablet computer. Computer system 500 can also be embedded in another device, for example, and without limitation, a mobile telephone, a personal digital assistant (PDA), a mobile audio player, a Global Positioning System (GPS) receiver, a video game console, and/or a television set top box.

The term “machine-readable storage medium” or “computer readable medium” as used herein refers to any medium or media that participates in providing instructions or data to processor 502 for execution. Such a medium may take many forms, including, but not limited to, non-volatile media, volatile media, and transmission media. Non-volatile media include, for example, optical disks, magnetic disks, or flash memory, such as data storage device 506. Volatile media include dynamic memory, such as memory 504. Transmission media include coaxial cables, copper wire, and fiber optics, including the wires that comprise bus 508. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Furthermore, to the extent that the term “include,” “have,” or the like is used in the description or the claims, such term is intended to be inclusive in a manner similar to the term “comprise” as “comprise” is interpreted when employed as a transitional word in a claim.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for providing an interface to refine a search query, the method comprising:
receiving a submission of a first search query in an input field;
providing, for display, the first search query in the input field with first search results for the search query, the first search results including at least one subset category of search results;
receiving a selection of the at least one subset category of the first search results; and
providing, for display, an indicator of the selected at least one subset category in the input field with second search results for the selected at least one subset category.

2. The method of claim 1, further comprising providing the indicator of the selected at least one subset category in the input field in response to a user selecting the input field after the second search results for the selected at least one subset category are provided for display.

3. The method of claim 1, further comprising:
receiving a submission of a second search query in the input field after the second search results for the selected at least one subset category are provided for display; and
providing, for display, third search results for the second search query limited to the selected at least one subset category.

4. The method of claim 1, wherein the providing, for display, the first search query in the input field with the first search results for the search query is limited to the first search results being provided using a secure connection.

5. The method of claim 4, wherein when the first search results are not provided using a secure connection, providing, for display, an address in the input field associated with a web page comprising the first search results to the first search query.

6. The method of claim 1, wherein the first search results comprise a plurality of subset categories, the plurality of subset categories comprising the selected at least one subset category.

7. The method of claim 6, wherein the plurality of subset categories comprise categories for images, videos, items for sale, maps, news, books, blogs, flights, discussions, recipes, and publications.

8. The method of claim 1, further comprising providing, for display in the input field, an option to deselect the selected at least one subset category.

9. The method of claim 1, wherein the input field comprises an omnibox configured to receive a search query and an address of a webpage.

10. The method of claim 1, wherein the indicator in the input field of the selected at least one subset category replaces another indicator in the input field indicating a search that is not limited to a subset category.

11. A system for providing an interface to refine a search query, the system comprising:
a memory comprising instructions;
a processor configured to execute the instructions to:
receive a submission of a first search query in an input field;
provide, for display, the first search query in the input field with first search results for the search query, the first search results including at least one subset category of search results;
receive a selection of the at least one subset category of the first search results;
provide, for display, an indicator of the selected at least one subset category in the input field with second search results for the selected at least one subset category;
receive a submission of a second search query in the input field after the second search results for the selected at least one subset category are provided for display; and
provide, for display, third search results for the second search query limited to the selected at least one subset category.

12. The system of claim 11, wherein the processor is further configured to provide the indicator of the selected at least one subset category in the input field in response to a user selecting the input field after the second search results for the selected at least one subset category are provided for display.

13. The system of claim 11, wherein the processor being configured to provide, for display, the first search query in the input field with the first search results for the search query is limited to the first search results being provided using a secure connection.

14. The system of claim 13, wherein when the first search results are not provided using a secure connection, the processor is configured to provide, for display, an address in the input field associated with a web page comprising the first search results to the first search query.

15. The system of claim 11, wherein the first search results comprise a plurality of subset categories, the plurality of subset categories comprising the selected at least one subset category.

16. The system of claim 15, wherein the plurality of subset categories comprise categories for images, videos, items for sale, maps, news, books, blogs, flights, discussions, recipes, and publications.

17. The system of claim 11, wherein the processor is further configured to provide, for display in the input field, an option to deselect the selected at least one subset category.

18. The system of claim 11, wherein the input field comprises an omnibox configured to receive a search query and an address of a webpage.

19. The system of claim 11, wherein the indicator in the input field of the selected at least one subset category replaces another indicator in the input field indicating a search that is not limited to a subset category.

20. A machine-readable storage medium comprising machine-readable instructions for causing a processor to execute a method for providing an interface to refine a search query, the method comprising:
receiving a submission of a first search query in an input field;
providing, for display, the first search query in the input field with first search results for the search query, the first search results including at least one subset category of search results;
receiving a selection of the at least one subset category of the first search results;
providing, for display, an indicator of the selected at least one subset category in the input field with second search results for the selected at least one subset category;
providing the indicator of the selected at least one subset category in the input field in response to a user selecting the input field after the second search results for the selected at least one subset category are provided for display,
wherein the providing, for display, the first search query in the input field with the first search results for the search query is limited to the first search results being provided using a secure connection, and
wherein when the first search results are not provided using a secure connection, providing, for display, an address in the input field associated with a web page comprising the first search results to the first search query.
